(19) United States
(12) Patent Application Publication
(10) Pub. No.: US 2017/0158560 A1
(43) Pub. Date: Jun. 8, 2017

(54) REACTIVE DILUENTS FOR CHEMICAL FIXING

(71) Applicant: fischerwerke GmbH & Co. KG, Waldachtal (DE)

(72) Inventors: Jürgen GRÜN, Bötzingen (DE); Martin VOGEL, Glotterta (DE); Christian SCHLENK, Denzlingen (DE); Yvonne HERBSTRITT, Waldkirch (DE); Carmen ANKERMANN, Denzlingen (DE)

(73) Assignee: fischerwerke GmbH & Co. KG, Waldachtal (DE)

(21) Appl. No.: 15/323,230

(22) PCT Filed: Jun. 12, 2015
(86) PCT No.: PCT/EP2015/001186

§ 371 Date: Dec. 30, 2016

(30) Foreign Application Priority Data
Jul. 4, 2014 (DE) 10 2014 109 355.0

(51) Int. Cl. C04B 24/26; C04B 40/06

(52) U.S. Cl. CPC C04B 24/2641; C04B 40/0666; C04B 2111/00715

(57) ABSTRACT

Free-radical-hardenable synthetic resin fixing systems which include one or more reactive diluents selected from oligoalkylene glycol di(meth)acrylates having on average more than two alkylene glycol units per molecule and alkoxylated tri-, tetra- and penta-methacrylates, and the use and production thereof, and further related subject matter.

The invention relates to new free-radical-hardenable reactive diluents for chemical fixing technology, to free-radical-hardenable (having olefinic double bonds in the reactive synthetic resin component) synthetic resin fixing systems which include such reactive diluents, to the use of such reactive diluents as reactive diluents for free-radical-hardenable synthetic resin fixing systems, to processes for the production of the synthetic resin fixing systems and/or methods for fixing, for example, anchoring means in drilled holes or crevices using the synthetic resin fixing systems which include at least one of such free-radical-hardenable reactive diluents.

The distribution and sale of chemical fixing systems is increasingly governed by the requirements and restrictions of chemicals legislation. For example, in some markets there are already restrictions on the sale of products of a certain hazard classification. There is therefore a need for fixing systems that have a low hazard classification or, if possible, are even non-hazard-classified. To meet this need, the problem of the present invention is the provision of suitable non-hazard-classified fixing systems.

Ethylene glycol di(meth)acrylate and diethylene glycol di(meth)acrylate are known reactive diluents for free-radical-hardenable resins in fixing technology, for example from EP 2 513 007 A.

It has now been found that free-radical-hardenable reactive diluents for free-radical fixing systems are possible that are based on oligoalkylene glycol di(meth)acrylates (preferred) or alkoxylated tri-, tetra- and penta-methacrylates, or in each case mixtures of two or more thereof.

It has been found that where the mixing conditions for the synthetic resin fixing systems according to the invention are poor during use, it is possible to achieve an optimum in respect of reactive-diluent action, advantageous hazard classification, acceptable mechanical parameters and good miscibility only within a specific range of the number of alkylene glycol repeating units. The content of alkylene glycol units on average per molecule (mean value) should be between 2.5 and 13, preferably between 3.5 and 10, especially between 4 and 8 and especially preferably between 4.2 and 7, such as, for example, between 4.5 and 6.

The polyalkylene glycol dimethacrylates according to the invention or to be used according to the invention are especially selected with a mean degree of polymerisation and polydispersity such that, in accordance with the legal basis currently in force for classification as “irritant” or “dangerous for the environment” under chemicals legislation (REGULATION (EC) No. 1272/2008 on the classification, labelling and packaging of substances and mixtures, amending and repealing Directives 67/548/EEC and 1999/45/EC, and amending Regulation (EC) No. 1907/2006—CLP Regulation),
the mean degree of polymerisation n is high enough to pass the tests mentioned under paragraphs 3.2 and 3.3, that is to say no irritation can be measured in the tests and accordingly no classification is made AND
the mean degree of polymerisation n is low enough also to pass the test described in Annex I, part 4, for an effect dangerous to the environment and accordingly in this case too no classification is made.

Surprisingly, the said free-radical-hardenable oligoalkylene glycol di(meth)acrylates (preferred) or alkoxylated tri-, tetra- and penta-methacrylates have been shown to be suitable for this use and exhibit unexpectedly good mechanical properties when used in fixing technology.

Preferably, the said free-radical-hardenable oligoalkylene glycol di(meth)acrylates are those of the formula I,

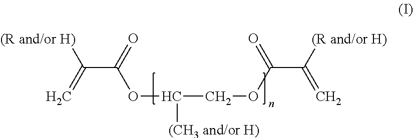

wherein the radicals R independently of one another denote C₁-C₇alkyl, especially methyl, and wherein n denotes on average from 2.5 to 13, preferably from 3.5 to 10, especially from 4 to 8 and more especially from 4.2 to 7, especially 4.5 and 6.

Examples of corresponding compounds are especially triethylene glycol di(meth)acrylate (TIEGDMA), tetraethylene glycol di(meth)acrylate (TTEGDMA), polyethylene glycol 200 di(meth)acrylate (PEG200DMA) (mean value n≈4.5) (most preferred), polyethylene glycol 400 di(meth)acrylate (PEG400DMA) (mean value n=9), furthermore polyethylene glycol 600 di(meth)acrylate (PEG600DMA) (mean value n=13).

In a first form of implementation the invention therefore relates to free-radical-hardenable synthetic resin fixing systems which include one or more reactive diluents selected from oligoalkylene glycol di(meth)acrylates (preferred) having on average more than two alkylene glycol units per molecule and alkoxylated tri-, tetra- and penta-methacrylates such as, for example, alkoxylated (for example ethoxylated or propoxylated) trimethylolpropane tri(meth)acrylate (SR492, SR415, SR454, SR492, SR499, SR502 from Sartomer), alkoxylated (for example ethoxylated or propoxylated) glycerol tri(meth)acrylate (SR9020, SR9046 from Sartomer), alkoxylated (for example ethoxylated or propoxylated) pentaerythritol tetra(meth)acrylate (SR494, SR596, Sartomer), especially oligoalkylene glycol di(meth)acrylates of the formula I shown above, preferably those specifically mentioned above and in the Examples.

In a second form of implementation the invention relates to the use of a synthetic resin fixing system, as defined hereinabove and hereinbelow, as an adhesive in fixing technology, especially for fixing anchoring means in drilled holes or crevices.

A third embodiment of the invention relates to a process for the production of the synthetic resin fixing systems, characterised in that reactive diluents, as defined hereinabove and hereinbelow, are mixed with the other constituents, especially a synthetic resin component in the case of a multi-component system, and especially, in the case of multi-component systems in separate compartments, are introduced into packagings.

A fourth embodiment of the invention relates to a method for fixing, for example, anchoring means in drilled holes or crevices using the synthetic resin fixing systems defined hereinabove and hereinbelow which include at least one of the free-radical-hardenable reactive diluents to be used according to the invention.

The reactive diluents for use in fixing systems according to the invention also form a subject matter of the invention.

The following definitions serve to clarify certain terms or symbols and to describe special forms of implementation of the invention; in the forms of implementation of the invention mentioned hereinabove and hereinbelow it is possible for individual, some or all of the terms or symbols to be replaced by more specific definitions, in each case resulting in special forms of implementation of the invention.

Where weights are given in percent (% by weight), unless otherwise specified they relate to the total mass of the reactants and additives of all components (in liquid and paste-form in the ready-formulated state) of the synthetic mortar fixing system, that is to say without packaging, i.e. the mass of all associated reactive resin formulation constituents.

“Free-radical-hardenable synthetic resin fixing systems (which have olefinic double bonds in the reactive synthetic resin component)” means especially that the synthetic resin fixing systems according to the invention are based on reactive synthetic resins, but may include, in addition to the constituents mentioned hereinabove and hereinbelow, also further customary ingredients (constituents; for example fillers, additives or other constituents mentioned hereinabove or hereinbelow). Such further ingredients can be present, for example, in an amount of in total up to 80% by weight, preferably between 0.01 and 65% by weight. Also, “based on” means especially that the constituent in question contains more than 50% by weight, preferably more than 60% by weight, such as more than 70% by weight, up to 100% by weight in each case (based on the constituent in question, for example “hardener”) of the substances mentioned after “based on”.

“Include” or “comprise” means that other components or features may be present in addition to the components or features mentioned and therefore denotes a non-exhaustive list, unlike “contain” the use of which does signify an exhaustive list of components or features.

Where the attribute “furthermore” is mentioned, this means that greater preference may be given to features without this attribute.

(Meth)acrylic denotes acrylic, methacrylic, or acrylic and methacrylic (as a mixture).

Free-radical-hardening unsaturated reactive synthetic resins are to be understood as being especially those which include, as free-radical curing (which includes curable (for example prior to addition of hardener)) components, organic compounds having unsaturated (for example olefinic) radicals or, especially, which consist thereof, especially those which comprise hardenable esters with unsaturated carboxylic acid radicals; for example especially (meth)acrylate or (meth)acrylamide monomers, such as acrylic acid and/or methacrylic acid, or preferably esters thereof (referred to as (meth)acrylates) or amides, especially (meth)acrylates such as mono-, di-, tri- or poly-(meth)acrylates (including hydroxypropyl (meth)acrylate, hydroxyethyl (meth)acrylate, ethylene glycol di(meth)acrylate, butanediol di(meth)acrylate, hexanediol dimethacrylate or (preferably in each case propoxylated or, especially, ethoxylated) aromatic diol-, such as bisphenol-A-, bisphenol-F- or novolak-(especially di-)(meth)acrylate), epoxy(meth)acrylates (especially in the form of reaction products of di- or poly-epoxides, for example bisphenol-A-, bisphenol-F- or novolak-di- and/or -poly-glycidyl ethers, with unsaturated carboxylic acids, for example C₂-C₇alkenecarboxylic acids, such as especially (meth)acrylic acid), urethane- and/or urea-(meth)acrylates (which, as the person skilled in the art knows, also comprises prelengthened and/or oligomeric urethane- and/or urea-(meth)acrylates), and/or unsaturated polyester resins, or the like; or a mixture of two or more of such hardenable unsaturated organic components.

Examples of epoxy(meth)acrylates present or used in special forms of implementation of the invention are those of the formula

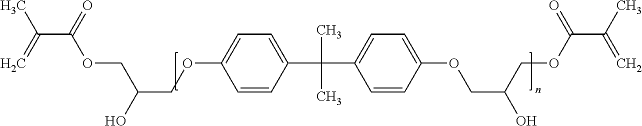

wherein n denotes a number greater than or equal to 1 (when mixtures of different molecules having different n values are present and are represented by the formula, non-integer numbers are also possible as a mean value).

Examples of propoxylated or, especially, ethoxylated aromatic diol-, such as bisphenol-A-, bisphenol-F- or novolak-(especially di-)(meth)acrylates that can be used in special forms of implementation of the invention are those of the formula

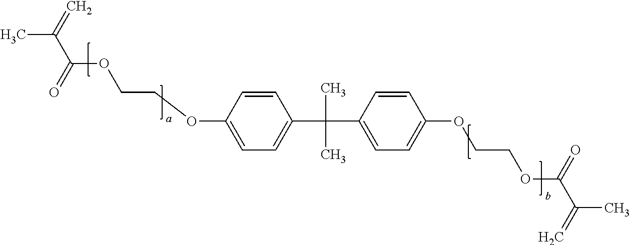

wherein a and b each independently of the other denote a number greater than or equal to 0, with the proviso that preferably at least one of the values is greater than 0, preferably both values being 1 or more (when mixtures of different molecules having different (a and b) values are present and are represented by the formula, non-integer numbers are also possible as a mean value).

Examples of urethane (meth)acrylates present or used in special forms of implementation of the invention are those which result, on the one hand, from the reaction of a prelengthened monomeric di- or poly-isocyanate and/or, on the other hand, from the reaction of a polymeric di- or poly-isocyanate (for example: PMDI, MDI and/or MDI) with hydroxyethyl- or hydroxypropyl-(meth)acrylate. The method of carrying out prelengthening reactions and the multiplicity of possible prelengthening reactions are known to the person skilled in the art and are not explicitly described herein. Reference may be made here by way of example to the applications EP 0 508 183 A1, EP 0 432 087 A1 and the as yet unpublished application of 14.02.2014 having the application number DE 10 2014 101 861.3.

The urethane methacrylates described in DE 10 2014 101 861.3 and preferred as free-radical-hardening unsaturated reactive synthetic resins in the forms of implementation of the invention are especially those obtainable in accordance with the following process:

The process is a process for the production of vinyl ester urethane resins, especially urethane (meth)acrylate resins (also referred to as U(M)A resins below), which is characterised in that, as starting material for the production of the vinyl ester urethane resin, especially a U(M)A resin, an isocyanate or an isocyanate mixture, in each case having a mean functionality of more than 2 (which can also be achieved by mixing isocyanates having a functionality of less than two with isocyanates having a functionality of greater than 2), for example from 2.1 to 5, for example from 2.2 to 4, advantageously, for example, from 2.3 to 3.5, is reacted with an aliphatic alcohol having at least one C—C double bond (non-conjugated—olefinic bond), especially a hydroxyalkyl (meth)acrylate, preferably hydroxy-lower alkyl (meth)acrylate, such as hydroxyethyl (meth)acrylate or especially hydroxypropyl (meth)acrylate, preferably 2-hydroxypropyl methacrylate (HPMA). The technically available HPMA is to be regarded as being a mixture of 2-hydroxypropyl methacrylate and hydroxyisopropyl methacrylate,—other aliphatic alcohols having an olefinic bond also can be present in the form of technical isomeric mixtures or in the form of pure isomers.

An isocyanate having a mean functionality of more than 2, for example from 2.1 to 5, for example from 2.2 to 4, advantageously, for example, from 2.3 to 3.5, is, for example, a polyisocyanate with uretdione, isocyanurate, iminooxadiazinone, uretonimine, biuret, allophanate and/or carbodiimide structures (advantageously with a molecular weight distribution such that no single molecule species is present in a proportion of more than 50% by weight and at the same time more than 50% by weight of the chains are composed of at least 3+1 covalently bonded monomer units/reactants (see the more precise definition of a polymer according to REACH)) or preferably a mixture (for example typically formed in technical production processes or subsequently specifically adjusted (for example by adding and/or distilling off monomers or monomer mixtures)) of (i) one or more monomeric mono- or especially di-isocyanates, such as diphenylmethane diisocyanate (MDI), especially 4,4′-diphenylmethyl diisocyanate or 2,2′-diphenylmethane diisocyanate or mixtures of diphenylmethane diisocyanate isomers (with different positions of the isocyanate groups on the phenyl nuclei), such as those just mentioned, with (ii) one or more “polymeric” diphenylmethane diisocyanates (PMDI), that is to say preferably crude MDI (crude product of the industrial production of MDI without separation of the individual isomers, for example by distillation) with (that is to say including) a plurality of isomers and higher-functional homologues and, for example, a mean molecular weight of the order of from 200 to 800 g/mol and a functionality as indicated above, for example having a mean molecular weight of from 280 to 500, for example from 310 to 480, and a functionality of from 2.4 to 3.4, for example of 3.2. Preference is given to commercially available PMDI that are obtained from the crude MDI itself or obtained from the crude MDI, for example, by distilling off and/or adding monomeric MDI, and have a mean molecular weight of 310-450 and can also include uretdione, isocyanurate, iminooxadiazinone, uretonimine, biuret, allophanate and/or carbodiimide structures. Special preference is given to commercially available PMDI having a molecular weight distribution such that no individual molecule species is present in a proportion of more than 50% by weight.

“Functionality” is to be understood as being the mean number of isocyanate groups per molecule; in the case of diphenylmethane diisocyanate this functionality is (substantially, that is to say apart from impurity-related variations) 2; in the case of the PMDI, it is a mean functionality (usually indicated by the manufacturer) which can be calculated according to the formula

$$f = \frac{\sum {n}_{i} \cdot {f}_{i}}{\sum {n}_{i}}$$

(f=functionality, nᵢ=number of molecules of a functionality fᵢ,) and is preferably between 2.1 and 5.0 or in the ranges as indicated above.

The process for the production of vinyl ester urethane resins, especially urethane (meth)-acrylate resins, preferably takes place in the presence of a catalyst, corresponding catalysts which catalyse the reaction between hydroxyl groups and isocyanate groups being sufficiently well known to the person skilled in the art, for example a tertiary amine, such as 1,2-dimethylimidazole, diazabicyclooctane, diazabicyclononane, or an organometal compound (for example of K, Sn, Pb, Bi, Al and especially of transition metals such as Ti, Zr, Fe, Zn, Cu); and also mixtures of two or more thereof; for example (based on the reaction mixture) in a proportion of from 0.001 to 2.5% by weight; preferably in the presence of stabilisers (inhibitors), such as, for example, phenothiazine, TEMPO, TEMPOL, hydroquinone, dimethylhydroquinone, triphenyl phosphite, tert.-butyl hydroquinone, hydro-quinone monoethyl ether, tert.-butylpyrocatechol and/or p-benzoquinone, and also mixtures of two or more thereof; for example in an amount of from 0.0001 to 2.5% by weight, based on the reaction mixture, at preferred temperatures, for example in the range of from 0 to 120° C., advantageously from 50 to 95° C.

Examples of suitable catalysts and stabilisers are known to the person skilled in the art, for example as can be seen from “Polyurethane Kunststoff-Handbuch 7” [Polyurethane Plastics Handbook 7″] by Becker, G. W.; Braun, D.; Oertel, G., 3rd edition, Carl Hanser Verlag, 1993.

The reaction can be carried out without solvent (the aliphatic alcohol having at least one C—C double bond, especially the hydroxy-(lower) alkyl (meth)acrylate itself, then serves as solvent) or in the presence of a suitable solvent, for example a further reactive diluent. “Reactive” here relates to the formulation of the adhesive and the curing thereof, not to the addition of the alcohol to the isocyanate.

The reaction can also be carried out by forming a prepolymer by means of prelengthening and only thereafter reacting the isocyanate groups that still remain with the aliphatic alcohol having at least one C—C double bond, especially with the hydroxy-(lower) alkyl (meth)-acrylate, as described hereinabove and hereinbelow.

For the preparation of the prepolymer, to achieve a mean isocyanate functionality of greater than two there are used the above-mentioned isocyanates and polyols having two or more hydroxy groups per molecule and/or polyamines having two or more amino groups per molecule or aminols having two or more amino and hydroxy groups per molecule, or there are used isocyanates having a functionality of 2 with polyols, polyamines or aminols having a mean OH and/or amino functionality of more than 2.

Polyols (di- or higher-functional alcohols) are especially di- or higher-functional alcohols, for example secondary products of ethylene oxide or propylene oxide, such as ethanediol, di- or tri-ethylene glycol, propane-1,2- or −1-3-diol, dipropylene glycol, other diols, such as 1,2-, 1,3- or 1,4-butanediol, 1,6-hexanediol, neopentyl glycol, 2-ethylpropane-1,3-diol or 2,2-bis(4-hydroxycyclohexyl)-propane, triethanolamine, bisphenol A or bisphenol F or the oxyethylation, hydrogenation and/or halogenation products thereof, higher-valent alcohols, such as, for example, glycerol, trimethylolpropane, hexanetriol and pentaerythritol, hydroxyl-group-containing polyethers, for example oligomers of aliphatic or aromatic oxirans and/or higher cyclic ethers, for example ethylene oxide, propylene oxide, styrene oxide and furan, hydroxy-terminated polyethers that contain aromatic structural units in the main chain, for example those of bisphenol A or F, hydroxyl-group-containing polyesters based on the above-mentioned alcohols or polyethers and dicarboxylic acids or their anhydrides, for example adipic acid, phthalic acid, isophthalic acid, terephthalic acid, tetra- or hexa-hydrophthalic acid, endomethylenetetrahydrophthalic acid, tetrachlorophthalic acid or hexachloroendomethylene tetrahydrophthalic acid, maleic acid, fumaric acid, itaconic acid, sebacic acid or the like. Special preference is given to hydroxyl compounds with aromatic structural units having a chain-stiffening effect, hydroxy compounds with unsaturated components for increasing the crosslinking density, such as fumaric acid, or branched or star-shaped hydroxy compounds, especially tri- or higher-functional alcohols and/or polyethers or polyesters that comprise structural units thereof. Special preference is given to lower alkanediols (yield divalent radicals —O-lower alkylene-O—).

Aminols (aminoalcohols) are compounds that contain especially one or more hydroxy groups and one or more amino groups in one and the same molecule. Preferred examples are aliphatic aminols, especially hydroxy-lower alkylamines (yield radicals —NH-lower alkylene-O— or —O-lower alkylene-NH—), such as ethanolamine, diethanolamine or 3-aminopropanol, or aromatic aminols, such as 2-, 3- or 4-aminophenol.

Polyamines (di- or higher-functional amines) are organic amino compounds having 2 or more amino groups, especially hydrazine, N,N′-dimethylhydrazine, aliphatic di- or poly-amines, especially lower alkanediamines (yield radicals —NH-lower alkyl-NH—), such as ethylenediamine, 1,3-diaminopropane, tetra- or hexa-methylenediamine or diethylene-triamine, or aromatic di- or poly-amines, such as phenylenediamine, 2,4- and 2,6-toluene-diamine, benzidine, o-chlorobenzidine, 2,5-p-dichlorophenylenediamine, 3,3′-dichloro-4,4′-diaminodiphenylmethane or 4,4′-diaminodiphenylmethane, polyether diamines (polyethylene oxides having terminal amino groups) or polyphenyl/polymethylene-polyamines that are obtainable by condensation of anilines with formaldehyde.

The ratio of free isocyanate groups of the isocyanate(s) to hydroxy groups of the hydroxy-lower alkyl (meth)acrylates is advantageously selected to be such that rapid and complete reaction of the isocyanate groups is obtained, that is to say the molar amount of hydroxy groups (and accordingly the correlating molar amount of hydroxy-lower alkyl (meth)acrylate) is greater than the molar amount of isocyanate groups, for example from 1.03 to 5 times greater, such as, for example, from 1.05 to 4 times greater or from 1.1 to 3 times greater. Excess hydroxy-lower alkyl (meth)acrylate serves as reactive diluent.

The U(M)A resins obtainable by means of this process are included as preferred unsaturated reactive resins in the embodiments of the invention.

In especially preferred forms of implementation of the subject matter of the invention, the oligoalkylene methacrylates to be used according to the invention are used in the production or for the reactive dilution of urethane methacrylate resins having a functionality f>2.1, especially having a functionality f>2.7. In a very especially preferred form of implementation the reactive resin (UM resin and all free-radical-hardenable additives) has a residual content of hydroxypropyl (meth)acrylate or hydroxyethyl (meth)acrylate resulting from the production of <4%, for example <3% and especially <1 or even <0.1%.

Especially in the case of the use of polyethylene glycol dimethylacrylate (PEG-DMA), such as PEG200DMA, the unsaturated polyurethane derivatives as described above are especially preferred as single representatives of the group of urethane methacrylates, and also the other free-radical-curing unsaturated reactive synthetic resins mentioned herein-before and hereinbelow apart from the other urethane methacrylates mentioned.

The free-radical-hardenable unsaturated reactive synthetic resin (or the total amount of its components) is present, for example, in a proportion by weight of from 1 to 99.5%, such as, for example, from 10 to 90%, for example from 15 to 80%.

Important examples of possible further ingredients (constituents) are (for example aminic) accelerators, inhibitors, reactive diluents, thixotropic agents, fillers and further additives.

Aminic accelerators that come into consideration are those having a sufficiently high activity, such as especially (preferably tertiary, especially hydroxyalkylamino-group-substituted) aromatic amines selected from the group comprising epoxyalkylated anilines, toluidines or xylidines, such as, for example, ethoxylated toluidine, aniline or xylidine, for example N,N-bis(hydroxymethyl or hydroxyethyl) toluidines or xylidines, such as N,N-bis(hydroxypropyl or hydroxyethyl) p-toluidine, N,N-bis(hydroxyethyl) xylidine and very especially corresponding higher alkoxylated technical products. One or more such accelerators are possible. The accelerators preferably have a content (concentration) of from 0.005 to 10%, especially from 0.1 to 5% by weight.

As inhibitors there can be added, for example, non-phenolic (anaerobic) and/or phenolic inhibitors.

As phenolic inhibitors (which are often provided as an already added constituent of commercially available free-radical-hardening reactive resins, but furthermore may also be absent) there come into consideration (non-alkylated or alkylated) hydroquinones, such as hydroquinone, mono-, di- or tri-methylhydroquinone, (non-alkylated or alkylated) phenols, such as 4,4′-methylene-bis(2,6-di-tert-butylphenol), 1,3,5-trimethyl-2,4,6-tris(3,5-di-tert-butyl-4-hydroxybenzyl)-benzene, (non-alkylated or alkylated) pyrocatechols, such as tert.-butylpyrocatechol, 3,5-di-tert-butyl-1,2-benzenediol or 4-tert.-butyl-1,2-benzenediol, or especially 4-methoxyphenol, or mixtures of two or more thereof. These preferably have a proportion of up to 1% by weight, especially between 0.0001 and 0.5% by weight, for example between 0.01 and 0.1% by weight.

As non-phenolic or anaerobic (that is to say, in contrast to phenolic inhibitors, effective also without oxygen) inhibitors (which especially have hardly any effect on curing times) there come into consideration preferably phenothiazine or organic nitroxyl free radicals. As organic nitroxyl free radicals it is possible to add, for example, those described in DE 199 56 509, which is incorporated herein by reference especially in respect of the compounds mentioned therein, especially 1-oxyl-2,2,6,6-tetramethylpiperidin-4-ol (“4-OH-TEMPO”). The proportion by weight of the non-phenolic inhibitors is preferably in the range of from 0.1 ppm to 2% by weight, preferably in the range of from 1 ppm to 1% by weight.

As thixotropic agents there can be used customary thixotropy-imparting rheology aids, such as pyrogenic silicic acid. They can be added, for example, in a proportion by weight of from 0.01 to 50% by weight, for example from 1 to 20% by weight.

As fillers there are used customary fillers, especially cements (for example Portland cements or high-alumina cements), chalks, sand, quartz sand, quartz powder or the like, which can be added in the form of powder, in granular form or in the form of shaped bodies, or other fillers, such as, for example, those mentioned in WO 02/079341 and WO 02/079293 (which in this regard are incorporated herein by reference), or mixtures thereof, it being possible for the fillers furthermore or especially also to be silanised, for example in the form of methacrylosilane-treated quartz powder, such as Silbond MST® from Quarzwerke GmbH, in the form of methacrylosilane-treated silica, such as Aktisil MAM® from Hoffmann Mineral, or methacryloxypropyltrimethoxysilane-treated pyrogenic silicic acid, such as Aerosil R 711® from Evonik. The fillers can be present in one or more components of a multi-component kit according to the invention, for example one or both components of a corresponding two-component kit; the proportion of fillers is preferably from 0 to 90% by weight, for example from 10 to 90% by weight (in the case of the installation of anchoring elements, broken casing material (for example splintered glass or splintered plastics), for example fragments of capsules, can be, and preferably is, also counted as filler). In addition or alternatively, hydraulically hardenable fillers, such as gypsum (for example anhydrite), calcined chalk or cement (for example alumina cement or Portland cement), water glass or active aluminium hydroxides, or two or more thereof, can be added.

Further additives may also be added, such as plasticisers, non-reactive diluents, flexibilisers, stabilisers, rheology aids, wetting agents and dyes. Such further additives can preferably be added in total in proportions by weight of in total from 0 to 90%, for example from 0 to 40% by weight.

The reactive diluents to be used according to the invention are preferably included in a proportion of from 0.1 to 90% by weight, especially from 0.5 to 75% by weight, especially from 1 to 40% by weight, in the synthetic resin fixing systems according to the invention.

Furthermore, it is possible for further reactive diluents to be added, especially those which likewise have an advantageous hazard classification. As “further reactive diluents” to preferred free-radical-hardening unsaturated reactive synthetic resins/vinyl esters there can be provided in addition also other hardenable unsaturated, such as olefinic, compounds, for example selected from mono-, di-, tri- or poly-(meth)acrylates, such as hydroxyalkyl (meth)acrylates, such as hydroxypropyl methacrylate (less preferred), other (meth)acrylic acid esters, such as (without this list being intended to be exhaustive) acetacetoxyalkyl (meth)acrylate, (meth)acrylic acid methyl ester, 1,4-butanediol di(meth)acrylate, trimethylolpropane tri(meth)acrylate or; furthermore styrenes, such as styrene, α-methylstyrene, vinyl toluene, tert.-butylstyrene and/or divinylbenzene, or mixtures of two or more thereof, as constituents that cure in parallel with the free-radical-hardening unsaturated reactive resin, for example in a proportion by weight of from 0.1 to 90% by weight, for example between 0.5 and 75% by weight or between 1 and 40% by weight. Preferably the addition of further reactive diluents is omitted. Particularly in the case of the use of only triethylene glycol dimethacrylate as reactive diluent to be used according to the invention, preferably the use of acetoacetato compounds, such as acetylacetone, acetoacetatoethyl methacrylate and triacetoacetato-trimethylolpropane as additional diluent should be omitted.

The hardener includes at least one peroxide as actual initiator. The term “hardener” here means preferably hereinabove and hereinbelow pure initiators or stabilised initiators with or without addition of filler and/or further additives, such as water, thickeners and/or further added ingredients, such as dyes, additives and the like, in other words a complete hardener component. For stabilisation, customary additives, such as gypsum, chalk, pyrogenic silicic acid, phthalates, chlorinated paraffin or the like, can be added. In addition, fillers and/or (especially for the preparation of a paste or emulsion) solvents, especially water, thickeners, fillers (for example those mentioned above) and further additives of those mentioned above can also be added, it being possible for water to serve as reactant for the hydrolysis of the silanes that include hydrolysable groups. The content of all additives can be, for example, a proportion by weight of in total from 0.1 to 70% by weight, for example from 1 to 40% by weight.

Based on the hardener component, the content of initiator in a possible preferred form of implementation of the invention is from 0.5 to 90% by weight, especially from 0.9 to 30% by weight.

As initiator for the hardening of the synthetic resin fixing systems according to the invention, in the case of the free-radical polymerisation there are used, for example, free-radical-forming peroxides, for example organic peroxides, such as diacyl peroxides, for example dibenzoyl peroxide, ketone peroxides, such as methyl ethyl ketone peroxide or cyclohexanone peroxide, or alkyl peresters, such as tert.-butyl perbenzoate, inorganic peroxides, such as persulfates or perborates, and also mixtures thereof.

The proportion of hardener in a synthetic resin fixing system according to the invention is in total preferably in a range of from 1 to 60% by weight, for example from 2 to 50% by weight, the proportion of peroxide, likewise based on the mass of the total associated synthetic mortar fixing system (100%), is especially 0.1% by weight or more, preferably from 1.5 to 10% by weight. In a special form of implementation the peroxide content is <1% by weight, based on the hardener; in a further possibility the peroxide content is <1% by weight, based on all components.

Alternatively, it is possible to use for the hardening of the reactive synthetic resin formulations according to the invention a hardener system which includes the constituents:
a) at least one activator in the form of a metal salt
b) as free-radical chain starter at least one compound including thiol and/or thiol ester groups.

By the combination or mixing of the two constituents it is possible for free radicals to be formed which, instead of free-radical formers customary hitherto, are able to initiate polymerisation of non-aromatic double bonds, e.g. olefinic double bonds, for example acrylates or methacrylates. Here reference is made to the patent application DE 10 2013 114 061.0 of 16.12.2013 SH-acid compounds) which in this regard is incorporated herein by reference.

Examples of thiols are thioglycerol, methyl-, ethyl-mercaptan and higher homologues, for example dodecylmercaptan; dimercaptans, such as dimercaptopropanesulphonic acid, dimercaptosuccinic acid, dithiothreitol; poly(ethylene glycol)dithiols, of the general formula HS—[CH₂—CH₂—O]ₙ—CH₂—CH₂—SH, wherein n denotes a number from 0 to 10; liquid polysulfide polymers having thiol end groups, for example Thioplast G types from Akzo Nobel; poly-mercaptan hardeners and crosslinkers, for example SIQ-Amin 999 from S.I.Q.-Kunstharze GmbH; ethoxylated and/or propoxylated alcohols from mono-, di-, tri-, tetra-, penta-ols and/or other polyols with thiol end groups, for example Capcure 3-800 from Cognis, or the compounds mentioned below as being especially suitable thiols. As especially suitable thiol esters mention may be made here of octanethioic acid S-[3-(triethoxysilyl)propyl] ester. Examples of especially suitable thiols are glycol di(3-mercaptopropionate), trimethylolpropane tri(3-mercaptopropionate), pentaerythritol tetra(3-mercaptopropionate), dipenta-erythritol hexa-3-mercaptopropionate, ethoxylated trimethylolpropane-tris(3-mercaptopropionate) having different degrees of ethoxylation (for example ETTMP 700 and ETTMP 1300 from Bruno Bock), tris[2-(3-mercaptopropionyloxy)ethyl] isocyanurate, 3-mercapto-propyl-trimethoxysilane.

As an alternative there can likewise be used for the hardening of the reactive synthetic resin formulations according to the invention a hardener system which includes the following constituents:
a) at least one activator in the form of a metal salt and
b) as free-radical chain starter at least one CH-acid compound of the formula A,

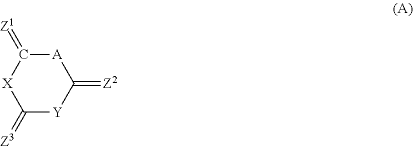

wherein
(i)
-A- denotes —C(R¹)(R²)—,
—X— denotes a bond, —NR³— or —(CR⁴R⁵)ₚ—, or denotes —O—,
Y denotes NR⁶ or denotes (CR⁷R⁵)_{q}, or denotes O,
wherein when X denotes O, Y also denotes O;
wherein preferably X denotes (CR⁴R⁵)ₚ and Y denotes CR⁷R⁸,
or X denotes NR³ and Y denotes NR⁶;
Z¹ denotes O, S, S═O or S(═O)₂,
Z² denotes O, S, S═O or S(═O)₂,
Z³ denotes O, S, S═O or S(═O)₂ or denotes R⁹ and R¹⁰,
p denotes 1, 2 or 3, preferably 1 or 2
q denotes 1, 2 or 3, preferably 1;
and the radicals R¹, R², R³, R⁴, R⁵, R⁶, R⁷, R⁸, R⁹ and R¹⁰ independently of one another denote hydrogen, alkyl, aryl, aralkyl, cycloalkyl or cycloalkylalkyl and are in each case unsubstituted or substituted and/or have hetero atoms (instead of C atoms; preferably selected from O, N, such as NH or N-alkyl, and S), with the proviso that at least one of the radicals R¹ and R² is hydrogen,
or
(ii) open-chain compounds,
wherein the bridge-forming member —C(═Z³)— is absent,
-A- denotes —C(R¹)(R²)—, X and Y each independently of the other denote an unbranched or branched, unsubstituted or substituted C₁-C₄alkyl group or C₁-C₄alkoxy group optionally having hetero atoms (instead of C atoms; especially selected from O, N, such as NH or N-alkyl, and S) or preferably denote an unsubstituted or substituted C₁-C₄alkoxycarbonylmethyl group or C₁-C₄alkylcarbonylmethyl group optionally having hetero atoms (instead of C atoms; especially selected from O, N, such as NH or N-alkyl, and S),
R¹ and R² both denote hydrogen and
Z¹ and Z² are as defined;
or X denotes an unbranched or branched, unsubstituted or substituted C₁-C₄alkyl group or C₁-C₄alkoxy group or C₁-C₄alkoxycarbonylmethyl group or C₁-C₄alkylcarbonylmethyl group optionally having hetero atoms (instead of C atoms; especially selected from O, N, such as NH or N-alkyl, and S),
Y and Z² together with the bonding carbon atom denote —CN,
Z¹ is as defined above, and
R¹ and R² are each as defined above, with the proviso that at least one of the radicals is hydrogen;
and/or salts thereof. Preferred examples of such compounds are 2,4,6-pyrimidinetrione derivatives, barbituric acid (2,4,6-pyrimidinetrione) itself, 1-benzyl-5-phenylbarbituric acid (1-(phenylmethyl)-5-phenyl-2,4,6-pyrimidinetrione), 5-butylbarbituric acid (5-butyl-2,4,6-pyrimidinetrione), 1-cyclohexyl-5-ethylbarbituric acid (1-cyclohexyl-5-ethyl-2,4,6-pyrimidinetrione) or 2-thiobarbituric acid (4,6-dihydroxy-2-mercaptopyrimidine), 1,3-cyclohexanedione, 2-methyl-1,3-cyclohexandione, 1,3-cyclopentanedione, 2-methyl-1,3-cyclopentanedione, 4,4-dimethyl-1,3-cyclohexanedione, 5,5-dimethyl-1,3-cyclohexanedione (dimedone), 2,2-dimethyl-1,3-dioxane-4,6-dione or 2,2,5-trimethyl-1,3-dioxane-4,6-dione, 3-oxoglutaric acid dimethyl ester, and/or diethyl-1,3-acetone dicarboxylate, ethylcyanoacetate, methylcyanoacetate or 2-ethylhexylcyanoacetate, or 1,3-dioxo compounds mentioned in DE 10 2011 078 785. Here reference is made to German patent application DE 10 2014 105 202.1 of 11.04.2014 which in this regard is incorporated by reference.

The components used as activators in the form of a metal salt, which also includes metal complexes and metal oxides, are in both cases preferably one or more metal salts or especially salts of organic and/or inorganic acids with metals, for example selected from cobalt, zirconium, zinc, cerium, tin, bismuth or preferably vanadium, manganese, copper or iron, or mixtures of two or more thereof, the organic acids preferably being saturated, preference being given to vanadium and iron or especially manganese and copper, optionally in the presence of one or two secondary activators with a metal component from the group of the above-mentioned metals, especially in the form of salts or complexes with inorganic acids and/or carboxylate radicals, such as carboxylates with CH₃, C₂-C₂₀alkyl, a C₆-C₂₄aryl radical or C₇-C₃₀aralkyl radical, for example octoate, for example 2-ethylhexanoate (isooctanoate), furthermore neodecanoate, or acetylacetonate. Special preference is given to manganese carbonate or carboxylates, such as Mn acetate or Mn octoate, copper carboxylates, such as copper octoate or copper naphthenate, copper quinolates, iron carboxylates, such as iron octoate and/or vanadium carboxylates and/or the group of metal salts with inorganic acids, which comprises, for example, iron chloride, iron sulphate and copper chloride.

Embodiments of the invention having the two said hardeners based on thiol or CH-acid compounds form preferred forms of implementation.

A hole or crevice is to be understood as being a hole or crevice that is present in a solid subsurface (substrate) (especially already completed as such), especially masonry or concrete, optionally also in a cracked substrate, such as cracked concrete, and is accessible from at least one side, for example a drilled hole, or furthermore a recessed region made during mortaring with inorganic mortar or plastering materials (such as with cement or gypsum), or the like.

In a special and advantageous form of implementation of the invention, the hardenable components and the associated hardeners (hardener components) of a synthetic resin fixing system according to the invention are stored separately from one another in a two-component or multi-component system before they are mixed with one another at the desired site (for example close to or in a hole or crevice, such as a drilled hole).

The hardenable compositions and especially synthetic resin fixing systems according to the invention can then be provided in the form of multi-component systems (for example a multi-component kit) and are also used as such.

A multi-component kit is especially to be understood as being a two-component or (furthermore) multi-component kit (preferably a two-component kit) having a component (A), which includes one or more reactive synthetic resins based on free-radical-hardenable (olefinic-bond-containing) reactive synthetic resins, as described hereinabove and hereinbelow, and the respectively associated hardener as component (B) defined hereinabove and hereinbelow, it being possible to provide further additives in one or both of the components, preferably a two-chamber or, furthermore, multi-chamber device, wherein the components (A) and (B) that are able to react with one another and optionally further separate components are present in such a way that their constituents cannot react with one another (especially with curing) during storage, preferably in such a way that their constituents do not come into contact with one another prior to use, but that enables components (A) and (B) and optionally further components to be mixed together for fixing at the desired location, for example directly in front of or in a hole, and if necessary introduced in such a way that the hardening reaction can take place therein. Also suitable are capsules, for example made of plastics, ceramics or especially glass, in which the components are separated from one another by means of rupturable boundary walls (which can be ruptured, for example, when an anchoring element is driven into a hole or a crevice, such as a drilled hole) or integrated separate rupturable containers, for example in the form of capsules, such as ampoules, arranged one inside the other; and also especially multi-component or especially two-component cartridges (which are likewise especially preferred), the chambers of which contain the plurality of components or preferably the two components (especially (A) and (B)) of the synthetic mortar fixing system according to the invention having the compositions mentioned hereinabove and hereinbelow for storage prior to use, the kit in question preferably also including a static mixer.

The free-radical-hardenable reactive diluent(s) to be used according to the invention, that is to say oligoalkylene glycol di(meth)acrylates (preferred) with on average more than two alkylene glycol units per molecule and/or alkoxylated tri-, tetra- and penta-methacrylates, or mixtures of two or more thereof, are then preferably provided in component (A).

The synthetic resin fixing systems according to the invention can preferably consequently be provided and also used preferably in the form of two-component or multi-component systems (multi-component kit). Two-component systems can also be those which include one component, for example in encapsulated form, in the other component.

The synthetic resin fixing systems are especially two-component systems in which the ratio by weight of component A to component B is from 99:1 to 1:99, from 99:1 to 50:50, from 99:1 to 60:40 or from 99:1 to 70:30.

The use of a synthetic resin fixing system according to the invention at the desired site of use or the method employing such use is effected especially by mixing the associated components (which are separate prior to mixing to inhibit reaction), especially close to and/or directly in front of a hole or (for example especially when cartridges having static mixers are used) directly in front of and/or (especially when suitable capsules or ampoules are ruptured) inside a hole or crevice, for example a drilled hole.

The installation (bonding in place) of the anchoring means preferably takes place only a short time, preferably 30 minutes or less, after the components of the synthetic resin fixing system according to the invention have been mixed. On mixing and introduction of the components onto or into the desired locations at which anchoring means are to be fixed, a plurality of reactions begin, which reactions take place substantially in parallel and/or with only a very small time interval between them. The final curing takes place in situ.

“Bonding in place” is especially to be understood as meaning (material-bonded and/or interlocking) fixing of anchoring means made of metal (for example undercut anchors, threaded rods, screws, drill anchors, bolts) or, furthermore, made of some other material, such as plastics or wood, in solid substrates (preferably already completed as such), such as concrete or masonry, especially insofar as they are components of artificially erected structures, more especially masonry, ceilings, walls, floors, panels, pillars or the like (for example made of concrete, natural stone, masonry made of solid blocks or perforated blocks, furthermore plastics or wood), especially in holes, such as drilled holes. Such anchoring means can then be used to secure, for example, railings, covering elements, such as panels, façade elements or other structural elements.

Where “mixtures of two or more thereof” are mentioned, this includes especially mixtures of at least one of the mentioned constituents that are highlighted as being preferred with one or more other components, especially one or more components likewise identified as being preferred.

“Completed as such” means especially that the substrates are, except for possible surface modifications (such as coating, for example plastering or painting) or the like, already complete (for example, as building modules or walls) and are not completed only at the same time as the adhesive or are not made from the latter. In other words: the adhesive is then not itself already-completed substrate.

Specific forms of implementation of the invention relate also to the variants mentioned in the claims and the abstract—the claims and the abstract are therefore incorporated herein by reference.

The Figures show:

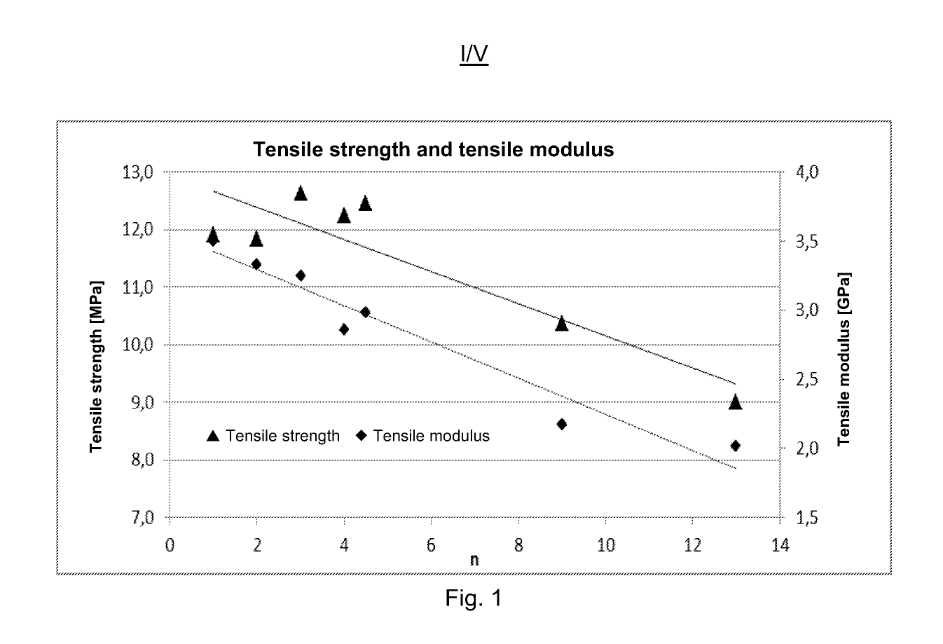

FIG. 1: compressive strengths and compressive moduli of the resins from Example 1 in dependence upon the mean number n of ethylene oxide units of the reactive diluents from Example 1;

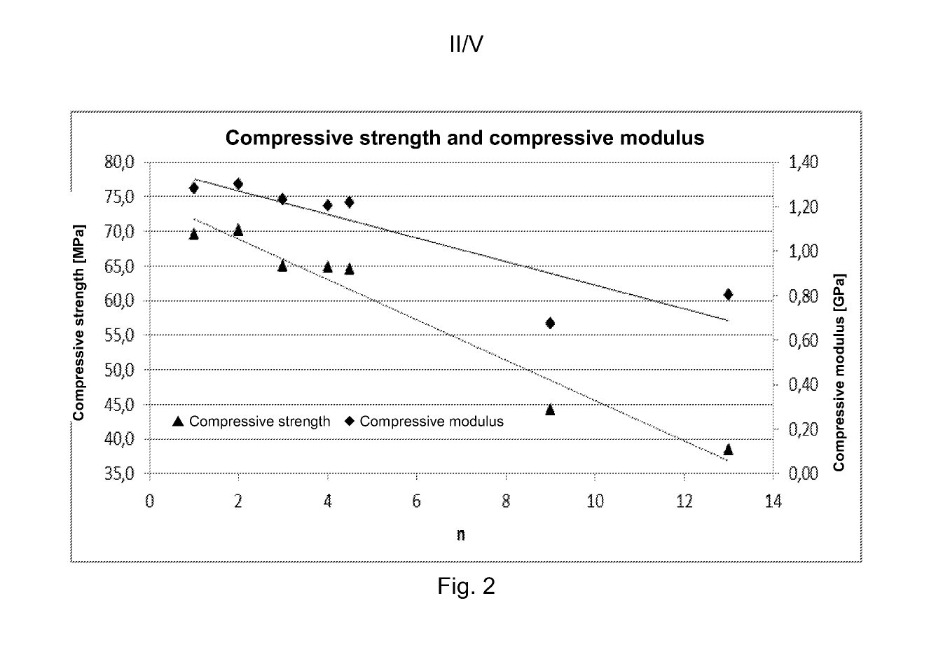

FIG. 2: bending tensile strengths and bending tensile moduli of the resins from Example 1 in dependence upon the mean number n of ethylene oxide units of the reactive diluents from Example 1;

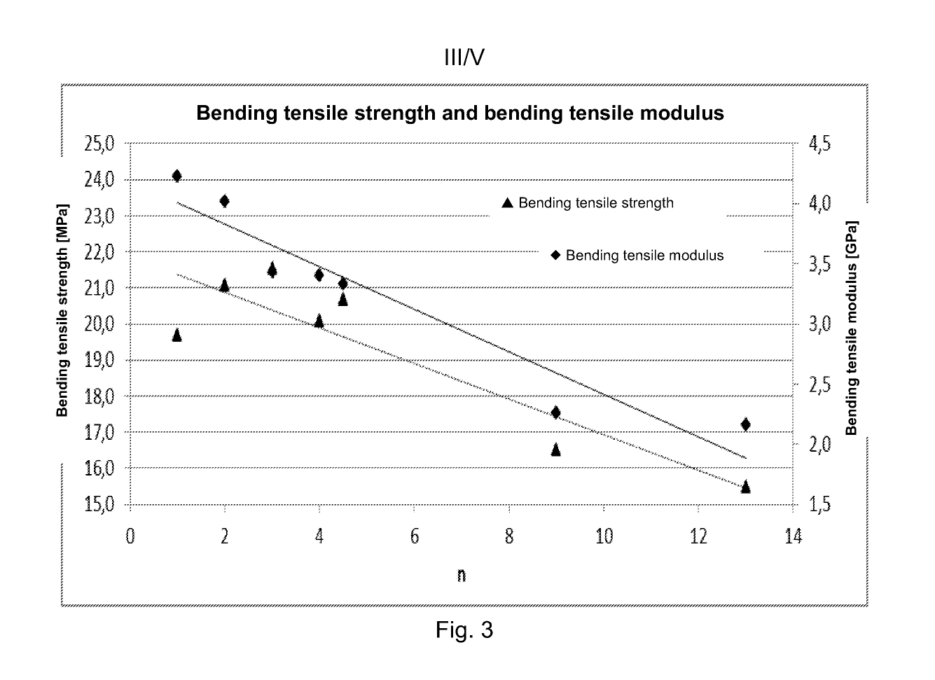

FIG. 3: bond stresses of the resins from Example 1 in dependence upon the mean number n of ethylene oxide units of the reactive diluents from Example 1;

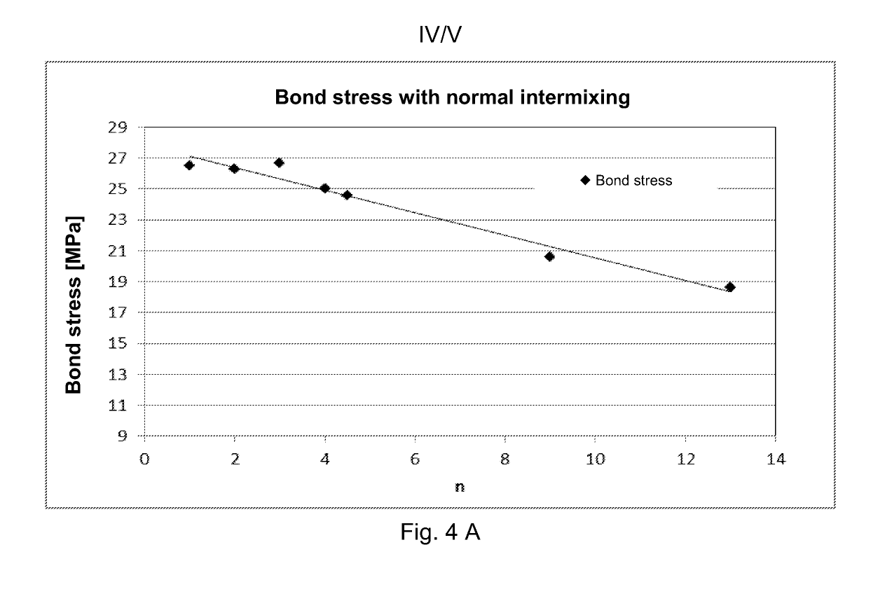

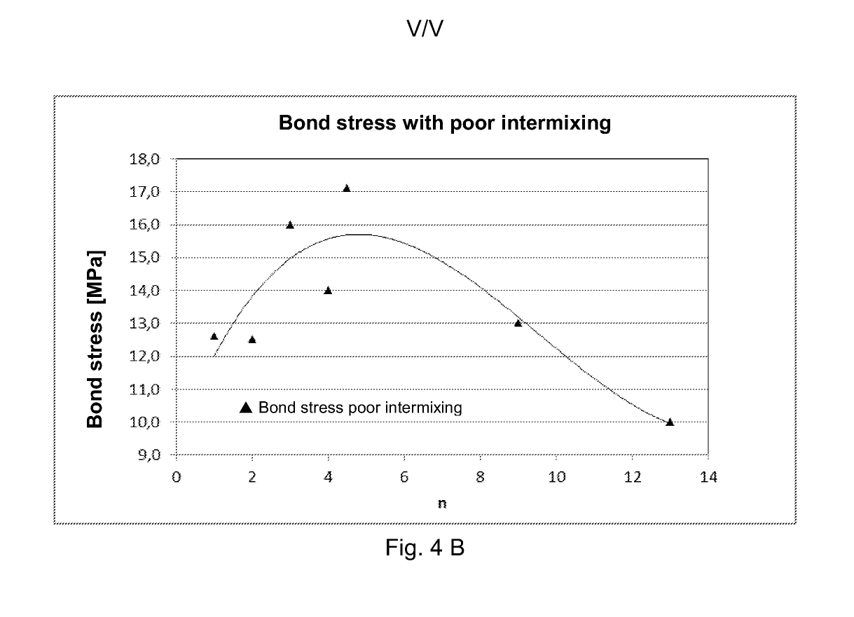

FIG. 4: comparison between bond stress in the case of poor intermixing (reduced-length static mixer) and normal intermixing for the resins from Example 1 in dependence upon the mean number n of ethylene oxide units of the reactive diluents from Example 1.

The inserted lines are to be understood only as showing the trend.

The Examples that follow serve as special forms of implementation which illustrate the invention but do not limit the scope thereof.

### EXAMPLE 1: INJECTABLE MORTAR ACCORDING TO THE INVENTION AND COMPARISON INJECTABLE MORTAR WITH REACTIVE DILUENTS

Two-component synthetic resin fixing systems were

Formulations for fixing systems:

| Raw material | Content [%] |
|---|---|
| Synthetic resin component | |
| Ethoxylated bisphenol-A-dimethacrylate | 25 |
| Reactive diluent* | 15 |
| Inhibitor mixture (selected from t-BBC, | 0.06 |
| hydroquinone and/or Tempol) | |
| Amine accelerator | 0.5 |
| Additives | 0.94 |
| Portland cement | 25 |
| Quartz powder 0.05-0.2 mm | 31.5 |
| Pyrogenic silicic acid | 2 |
| Total | 100 |
| Hardener | |
| Water, demineralised | 30 |
| Stabilised dibenzoyl peroxide (33%) | 42 |
| Quartz sand | 26.5 |
| Additives and thickeners | 1.5 |
| Total | 100 |

*As reactive diluents the following were used:

| | | | Number (where |
|---|---|---|---|
| | | | applicable mean |
| | Comparison or | | number) of ethylene |
| | according to the | Viscosity | oxide units in |
| Reactive diluent | invention | [mPa*s] | formula I (n) |
| Ethylene glycol | comparison | 3-9 | 1 |
| dimethacrylate | | | |
| (EGDMA) | | | |
| Diethylene glycol | comparison | 10 | 2 |
| dimethacrylate | | | |
| (DEGDMA) | | | |
| TIEGDMA | according to the | 5-16 | 3 |
| | invention | | |
| TTEGDMA | according to the | 9-15 | 4 |
| | invention | | |
| SR210 (Sartomer) | according to the | 13-16 | 4.5 |
| | invention, most | | |
| | preferred | | |
| PEG400DMA | according to the | 20-70 | 9 |
| | invention | | |
| PEG600DMA | according to the | 60-80 | 13 |
| | invention | | |

The viscosity data are manufacturer's data and relate to 25° C.

In order to simulate poor mixing conditions, the synthetic resin component and the hardener were introduced in a ratio by volume of 5:1 into separate cartridge chambers of a commercially available fischer shuttle cartridge and introduced into drilled holes using a normal static mixer FIS V or a static mixer FIS V that had been reduced in length (from normally eight) to three windings (fischerwerke GmbH & CO KG, Waldachtal, Deutschland). This simulates poor mixing conditions, such as can be brought about, for example, by air bubbles formed during storage or by an increase in viscosity during storage.

FIGS. 1 and 2 show the compressive strengths and compressive moduli (FIG. 1) and the bending tensile strengths and the bending tensile modulus (FIG. 2) of the resins after curing in dependence upon the mean number n of ethylene oxide units.

The values decrease as the number n of ethylene oxide units increases, but values are still acceptable and usable even at n=13.

The corresponding measured values and further measured values can be found in the Tables below:

The tensile strength and the tensile modulus are determined using dumbbell test specimens of type 1 BA in accordance with DIN EN ISO 527; the compressive strength and the compressive modulus are measured in accordance with DIN EN ISO 604; the bending tensile strength and the bending tensile modulus are measured in accordance with DIN EN ISO 178, in each case using specimens after curing for 7 days at 23° C.

The bond stress is determined by 5 setting tests using M12 anchor rods in concrete (C20/C25) with a setting depth of 95 mm and a drilled hole diameter of 14 mm after a curing time of 60 min at 20° C. and a subsequent pull-out test.

| | | | Elongation |
|---|---|---|---|
| | Tensile strength after | Tensile modulus | at tensile |
| n | 24 h [MPa] | [GPa] | strength [%] |
| 1 | 11.9 | 3.5 | 0.5 |
| 2 | 11.8 | 3.3 | 0.5 |
| 3 | 12.6 | 3.3 | 0.7 |
| 4 | 12.3 | 2.9 | 0.8 |
| 4.5 | 12.5 | 3.0 | 0.8 |
| 9 | 10.4 | 2.2 | 0.8 |
| 13 | 9.0 | 2.0 | 0.6 |

| | Compressive | | Compression at |
|---|---|---|---|
| | strength after 24 h | Compressive | compressive strength |
| n | [MPa] | modulus [GPa] | [%] |
| 1 | 69.6 | 1.28 | 8.8 |
| 2 | 70.2 | 1.30 | 10.5 |
| 3 | 65.0 | 1.23 | 10.0 |
| 4 | 64.8 | 1.20 | 11.4 |
| 4.5 | 64.5 | 1.22 | 12.8 |
| 9 | 44.2 | 0.67 | 12.2 |
| 13 | 38.6 | 0.80 | 11.5 |

FIG. 3 shows the bond stress in dependence upon the mean number n of ethylene oxide units. Here too there is a decrease as n increases.

The corresponding measured values and further measured values can be found in the following Table:

| | | Bending | Bending | |
|---|---|---|---|---|
| | Bending tensile | tensile | tensile | Bending at |
| | strength after 24 h | modulus | modulus | bending tensile |
| n | [MPa] | [MPa] | [GPa] | strength [%] |
| 1 | 19.7 | 4228 | 4.2 | 0.6 |
| 2 | 21.1 | 4013 | 4.0 | 0.7 |
| 3 | 21.6 | 3433 | 3.4 | 0.9 |
| 4 | 20.1 | 3405 | 3.4 | 0.9 |
| 4.5 | 20.7 | 3335 | 3.3 | 0.9 |
| 9 | 16.5 | 2258 | 2.3 | 1.2 |
| 13 | 15.5 | 2158 | 2.2 | 1.2 |

FIG. 4 shows the measurement of the bond stress in the case of poor intermixing (FIG. 4 B—reduced-length static mixer) in comparison with good intermixing (FIG. 4 A—static mixer not reduced in length). In this case there is a plateau in the range from n=2.5 to approximately n=9. This shows that under conditions of poor intermixing, synthetic resin fixing systems according to the invention surprisingly have advantages over those having 1 or 2 ethylene oxide units (EGDMA or DEGDMA).

The corresponding measured values can be found in the following Table:

| | Bond stress [N/mm²] | Bond stress [N/mm²] |
|---|---|---|
| n | Normal intermixing | Poor intermixing |
| 1 | 26.5 | 12.6 |
| 2 | 26.3 | 12.5 |
| 3 | 26.7 | 16.0 |
| 4 | 25 | 14.0 |
| 4.5 | 24.6 | 17.1 |
| 9 | 20.6 | 13.0 |
| 13 | 18.6 | 10.0 |

### EXAMPLE 2: PREPARATION OF A NON-HAZARD-CLASSIFIED URETHANE METHACRYLATE REACTIVE RESIN

In a 1000 ml glass flask equipped with a reflux condenser having a drying tube, stirrer, dropping funnel and thermometer, 170.94 g of HPMA, 268.86 g of SR210, 1.07 g of KAT 20% in SR210, 0.3 g of STAB1 5% in SR210, 1.2 g of STAB2 10% in HPMA are used as initial charge and heated in an oil bath at 60° C. The PMDI (Desmodur VKS 20, Bayer AG; average functionality about 2.7) was slowly added dropwise to the reaction mixture so that the temperature did not exceed 90° C. When the addition of the PMDI was complete, stirring was continued at 80° C. in order to complete the reaction. Full reaction (freedom from isocyanate groups detectable by IR spectroscopy) was checked by means of FT-IR. The content of free HPMA was <0.3% (calculated and confirmed by GC analysis).

### EXAMPLE 3: PREPARATION OF A NON-HAZARD-CLASSIFIED FIXING SYSTEM

| Raw material | Content [%] |
|---|---|
| Synthetic resin component | |
| UM resin Example 2 | 25 |
| SR210 | 15 |
| Inhibitor mixture (selected from t-BBC, | 0.06 |
| hydroquinone and/or Tempol) | |
| Amine accelerator | 0.5 |
| Additives | 0.94 |
| Quartz powder 0.05-0.2 mm | 56.5 |
| Pyrogenic silicic acid | 2 |
| Total | 100 |
| Hardener | |
| Water, demineralised | 30 |
| Stabilised dibenzoyl peroxide (33%) | 17 |
| Filler | 51 |
| Additives and thickeners | 2 |
| Total | 100 |

445 g of the mortar and 85 g of the hardener are introduced into a commercially available fischer Multibond cartridge (ratio by volume about 5:1). Using the injection system, 5 setting tests are carried out using M12 anchor rods in concrete (C20/C25) with a setting depth of 95 mm and a drilled hole diameter of 14 mm and, after a curing time of 60 min at 20° C., subjected to a pull-out test. Very good bond stresses of 22 N/mm² are obtained.

### EXAMPLE 4

Preparation of a Non-Hazard-Classified Fixing System which Contains an Epoxyacrylate as Reactive Resin.

| Raw material | Content [%] |
|---|---|
| Synthetic resin component | |
| Epoxyacrylate CN159 (Sartomer) | 20 |
| SR210 | 20 |
| Inhibitor mixture (selected from t-BBC, | 0.001 |
| hydroquinone and/or Tempol) | |
| Amine accelerator | 3 |
| Additives | 0.999 |
| Quartz powder 0.05-0.2 mm | 54 |
| Pyrogenic silicic acid | 2 |
| Total | 100 |
| Hardener | |
| Water, demineralised | 35 |
| Stabilised dibenzoyl peroxide (33%) | 2.95 |
| Filler | 60 |
| Additives and thickeners | 2.05 |
| Total | 100 |

Mortar and hardener are introduced into a commercially available fischer shuttle cartridge (ratio by volume about 3:1). Good bond stresses of 18 N/mm² are obtained.

1. A free-radical-hardenable synthetic resin fixing system which includes one or more reactive diluents selected from oligoalkylene glycol di(meth)acrylates having on average more than two alkylene glycol units per molecule and alkoxylated tri-, tetra- and penta-methacrylates.

2. The free-radical-hardenable synthetic resin fixing system according to claim 1, wherein the free-radical-hardenable oligoalkylene glycol di(meth)acrylates are those of the formula I, 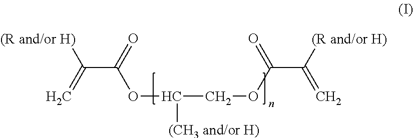
wherein the radicals R independently of one another denote C₁-C₇alkyl, especially methyl, and wherein n denotes on average from 2.5 to 13, preferably from 2.5 to 12, especially from 3.5 to 10, preferably from 4 to 8, especially preferably from 4.2 to 7, very especially from 4.5 to 6.

3. The free-radical-hardenable synthetic resin fixing system according to claim 2, wherein the free-radical-hardenable oligoalkylene glycol di(meth)acrylates are those of the formula I, wherein n denotes from 3 to 8 and R denotes methyl.

4. The free-radical-hardenable synthetic resin fixing system according to claim 1, wherein they are based on reactive synthetic resins selected from (meth)acrylate or (meth)acrylamide monomers, such as acrylic acid and/or methacrylic acid or preferably esters or amides thereof, especially (meth)acrylates such as mono-, di-, tri- or poly-(meth)acrylates, optionally in each case propoxylated or ethoxylated aromatic diol-, such as bisphenol-A-, bisphenol-F- or novolak-(especially di-)(meth)acrylate), epoxy(meth)acrylates (especially in the form of reaction products of di- or poly-epoxides, for example bisphenol-A-, bisphenol-F- or novolak-di- and/or -poly-glycidyl ethers, with unsaturated carboxylic acids, for example C₂-C₇alkenecarboxylic acids, such as especially (meth)acrylic acid), urethane- and/or urea-(meth)acrylates and unsaturated polyester resins; or a mixture of two or more of such hardenable unsaturated organic components, and also a hardener and no further ingredients or preferably one or more further ingredients.

5. The free-radical-hardenable synthetic resin fixing system according to claim 1, wherein they are based on reactive synthetic resins selected from those of the formula 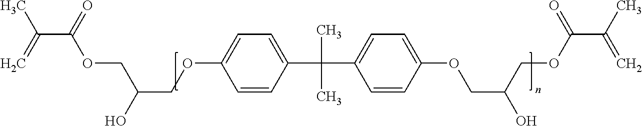
wherein m denotes a number greater than or equal to 1,
those of the formula 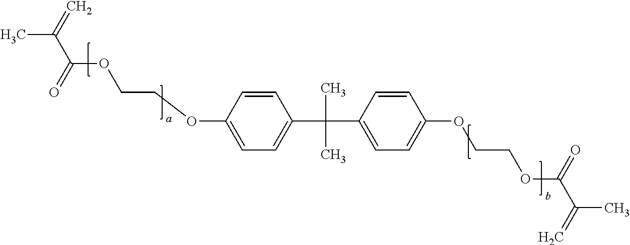
wherein a and b each independently of the other denote a number greater than or equal to 0, with the proviso that preferably at least one of the values is greater than 0, preferably both values being 1 or more; and
urethane (meth)acrylates which result from the reaction of a prelengthened monomeric di- or poly-isocyanate and/or from the reaction of a polymeric di- or poly-isocyanate (for example: PMDI, MDI and/or MDI) with hydroxyethyl- or hydroxypropyl-(meth)acrylate.

6. The free-radical-hardenable synthetic resin fixing system according to claim 1, wherein it includes the reactive diluent(s) in a proportion by weight of from 0.1 to 90% by weight, especially from 0.5 to 75% by weight, especially from 1 to 40% by weight; and a/the reactive synthetic resin in a proportion by weight of from 1 to 99.5%, such as, for example, from 10 to 90%, for example from 15 to 80%; and preferably further ingredients in an amount of in total up to 80% by weight, preferably between 0.01 and 65% by weight.

7. The free-radical-hardenable synthetic resin fixing system according to claim 1 in the form of a multi-component system, especially two-component system, wherein the reactive diluent(s) are selected from triethylene glycol di(meth)acrylate, tetraethylene glycol di(meth)acrylate, polyethylene glycol 200 di(meth)acrylate, polyethylene glycol 400 di(meth)acrylate, and furthermore polyethylene glycol 600 di(meth)acrylate.

8. The free-radical-hardenable synthetic resin fixing system according to claim 1, wherein as free-radical-hardening unsaturated reactive synthetic resin there are used urethane methacrylates which are obtainable by reacting, as starting material for the production of the vinyl ester urethane resin, especially a U(M)A resin, an isocyanate or an isocyanate mixture having a mean functionality of more than 2, which can also be achieved by mixing isocyanates having a functionality of less than two with isocyanates having a functionality of greater than 2, for example a functionality of ≧2.1, preferably ≧2.7, especially from 2.1 or 2.7 to 5, for example from 2.2 or 2.7 to 4, advantageously, for example, from 2.3 or 2.7 to 3.5, with an aliphatic alcohol having at least one C—C double bond (non-conjugated -olefinic bond), especially a hydroxyalkyl (meth)acrylate, preferably hydroxy-lower alkyl (meth)acrylate, such as hydroxyethyl (meth)acrylate or especially hydroxypropyl (meth)acrylate, preferably 2-hydroxypropyl methacrylate (HPMA).

9. The free-radical-hardenable synthetic resin fixing system according to claim 1, wherein it includes one or more further reactive diluents, selected from mono-, di-, tri- or poly-(meth)acrylates, such as hydroxyalkyl (meth)acrylates, such as hydroxypropyl methacrylate, other (meth)acrylic acid esters selected from (meth)acrylic acid methyl ester, 1,4-butanediol di(meth)acrylate, 1,2-ethanediol di(meth)acrylate, diethyl glycol di(meth)acrylate, trimethylolpropane tri(meth)acrylate or polyethylene glycol di(meth)acrylate; and styrenes, such as styrene, α-methylstyrene, vinyl toluene, tert.-butylstyrene and/or divinylbenzene, or mixtures of two or more thereof.

10. The free-radical-hardenable synthetic resin fixing system according to claim 1, wherein as free-radical-hardening unsaturated reactive synthetic resin it includes one without cyclic unsaturated groups.

11. The free-radical-hardenable synthetic resin fixing system according to claim 1, wherein it includes a hardener having a peroxide content of <1% by weight, based on the hardener, preferably having a peroxide content of <1% by weight, based on all components.

12. A method comprising using a synthetic resin fixing system according to claim 1 as an adhesive in fixing technology, especially for fixing anchoring means in drilled holes or crevices.

13. A process for the production of a synthetic resin fixing system according to claim 1, wherein reactive diluents, are mixed with the other constituents, especially a synthetic resin component in the case of a multi-component system, and especially, in the case of multi-component systems in separate compartments, are introduced into packagings.

14. A method for fixing, for example, anchoring means in drilled holes or crevices using the synthetic resin fixing systems according to claim 1, which include at least one of the free-radical-hardenable reactive diluents to be used according to the invention, including mixing the associated components, especially close to and/or directly in front of a hole or directly in front of and/or inside a hole or crevice, for example a drilled hole, and bonding an/the anchoring means in place.
